(19) United States
(12) Patent Application Publication
(10) Pub. No.: US 2010/0186005 A1
(43) Pub. Date: Jul. 22, 2010

(54) COMPUTER READABLE RECORDING MEDIUM STORING VERIFICATION SUPPORT PROGRAM, INFORMATION PROCESSING APPARATUS AND VERIFICATION SUPPORT METHOD

(75) Inventor: Atsushi IKE, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/570,241

(22) Filed: Sep. 30, 2009

(30) Foreign Application Priority Data
Jan. 20, 2009 (JP) 2009-009873

(51) Int. Cl. G06F 9/44

(52) U.S. Cl. 717/135

(57) ABSTRACT

A verification support program executes a simulation of an application executed by a system using a virtual machine implementing a hardware environment of the system by software. The program acquires a simulation model of hardware to be added to the hardware environment and the application has specific code inserted into a location where the hardware to be added is invoked. The program detects the location into which the specific code is inserted from the application being executed when the application acquired by the acquiring procedure is executed by the execute procedure. The program perform-controls the simulation of the application by using information of the simulation model acquired by the acquire procedure in the location where insertion of the specific code is detected by the detect procedure by controlling the execute procedure. The program outputs a simulation result of the application by the execute procedure.

### CROSS-REFERENCE TO RELATED APPLICATION

This application is based upon and claims the benefit of priority of the prior Japanese Patent Application No. 2009-009873, filed on Jan. 20, 2009, the entire contents of which are incorporated herein by reference.

### FIELD

Various embodiments described herein relate to a computer readable recording medium that stores a verification support program to verify a predetermined application using execution results of a simulation, an information processing apparatus, and a verification support method.

### BACKGROUND

To develop an application operating on a specific OS (Operating System), it has been necessary to consider a hardware environment to cause the OS to operate. When a new hardware macro, such as a 3D accelerator, is added to an existing hardware environment, processing, such as invoking a hardware macro from an application, cannot be performed without preparing a driver corresponding to the hardware macro. Thus, when an application intended to be executed in a hardware environment like one created by adding an optional hardware macro to an existing system is developed, a driver to invoke the added hardware macro needs first to be prepared.

FIG. 14 is an explanatory view illustrating conventional application development steps. When an optional hardware macro is added, as illustrated in FIG. 14, a hardware macro itself is first developed and after development of the hardware macro is completed, a transition to development of a driver corresponding to the hardware macro occurs (step 1). Similarly, after development of the driver is completed, an application is developed (step 2). Then, verification processing, that is, an estimation of performance/power of the application can be formed by causing hardware to execute the application developed at step 2 (step 3).

In recent years, an evaluation control program to bridge an application and hardware has been provided as a technology that enables an evaluation of the application on a real machine without waiting for, as described above, development of a hardware macro or a driver. By using such a program, an application can also be evaluated in an earlier stage of system development (Japanese Patent Application Laid-Open No. 2000-293403).

However, an evaluation control program to bridge an application and hardware described above implements hardware to be developed by software using a virtual API (Application Program Interface) on specific hardware that is different from hardware to be developed and caused to actually execute the application. That is, such an evaluation control program performs only a simulation of an application in an alternate hardware environment. Therefore, there remains an issue that it is impossible to obtain high-precision information as a simulation result because a hardware environment that is different from a hardware environment in which the application is actually caused to run is used.

To obtain a high-precision simulation result, as described above with reference to FIG. 14, development of an application is in a standby state until a hardware macro to be added to a hardware environment and a driver corresponding to the hardware macro are developed. As a result, there is an issue that quite a long time is needed to develop an application.

Moreover, according to conventional development steps illustrated in FIG. 14, it becomes possible to develop an application only after development of a hardware macro and a driver is completed. Therefore, in order to give feedback of simulation results of a developed application to the configuration of a hardware macro, it is necessary to return to the development of a hardware macro again to correct the hardware macro before developing a driver corresponding to the corrected hardware macro. As a result, even if verification results can be utilized, there is an issue that application development is seriously delayed.

### SUMMARY

An information processing apparatus having a verification support function, includes an execution unit for executing a simulation of an application executed by a system using a virtual machine implementing a hardware environment of the system by software, an acquisition unit for acquiring a simulation model of hardware to be added to the hardware environment and the application having specific code inserted into a location where the hardware to be added is invoked, a detection unit for detecting the location into which the specific code is inserted from the application being executed when the application acquired by the acquisition unit is executed by the execution unit, a control unit for performing the simulation of the application by using information of the simulation model acquired by the acquisition unit in the location where insertion of the specific code is detected by the detection unit by controlling the execution unit and an output unit for outputting a simulation result of the application by the execution unit.

The object and advantages of the invention will be realized and attained by means of the elements and combinations particularly pointed out in the claims. It is to be understood that both the foregoing general description and the following detailed description are exemplary and explanatory and are not restrictive of the various embodiments, as claimed.

### BRIEF DESCRIPTION OF DRAWINGS

FIG. 1 is an explanatory view illustrating an overview of verification support processing according to an embodiment;

FIG. 2 is an explanatory view illustrating the configuration of a virtual machine according to an embodiment;

FIG. 3 is an explanatory view illustrating a procedure for basic operations in the virtual machine;

FIG. 4 is a block diagram illustrating the hardware configuration of an information processing apparatus;

FIG. 5 is an explanatory view illustrating the procedure for performing a simulation in the information processing apparatus;

FIG. 6 is a block diagram illustrating the functional configuration of the virtual machine in the information processing apparatus;

FIG. 7 is an explanatory view illustrating the procedure for performing a simulation using the virtual machine;

FIG. 8 is a model diagram illustrating an example of hardware macro invocation by the virtual machine;

FIG. 9 is an explanatory view illustrating a description example of an application including a hardware macro invocation;

FIG. 10 is an explanatory view illustrating simulation control of the virtual machine in accordance with mark detection;

FIG. 11 is an explanatory view illustrating mark insertion examples of the application;

FIG. 12 is an explanatory view illustrating the simulation procedure of the virtual machine including the hardware macro;

FIG. 13 is an explanatory view illustrating application development steps when the present embodiment is applied;

FIG. 14 is an explanatory view illustrating conventional application development steps.

### DESCRIPTION OF EMBODIMENTS

Embodiments of the verification support program, information processing apparatus, and verification support method will be described in detail below with reference to attached drawings. In the verification support program, information processing apparatus, and verification support method, an application including specific code (for example, a predetermined mark distinguishable by a virtual machine) is prepared in a location where processing to invoke hardware (hardware macro) whose driver is not provided is described. Then, the application is simulated by causing the virtual machine to execute the application. The virtual machine performs a simulation of the application in the location where the specific code is detected by using information about a simulation model of the hardware macro. That is, the virtual machine can directly be invoked from the application without using a driver. A concrete configuration of the verification support program, information processing apparatus, and verification support method that enables such an operation will be described below.

### (Overview of Verification Support Processing)

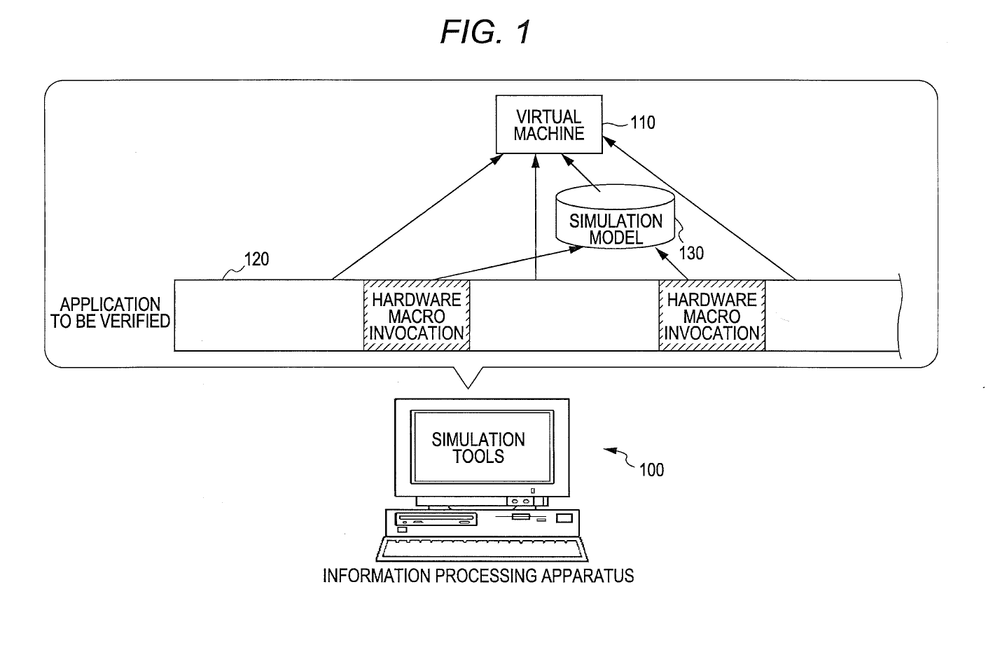

First, an overview of verification support processing according to the present embodiment will be provided. FIG. 1 is an explanatory view illustrating an overview of verification support processing according to the present embodiment. In the present embodiment, as illustrated in FIG. 1, an execution time and power consumption of an application 120 can be evaluated by simulating the application 120 to be evaluated using simulation tools implemented in an information processing apparatus 100.

In the verification support processing according to the present embodiment, a virtual machine 110 implementing a hardware environment by software caused to execute the application 120 is provided in the information processing apparatus 100. A simulation of the application 120 is performed by the virtual machine 110, but a hardware environment that can be implemented by the virtual machine 110 is only developed hardware for which a corresponding driver is prepared.

Therefore, in the information processing apparatus 100, a simulation model 130 corresponding to a hardware macro is provided so as to perform a simulation of the application 120 that invokes, for example, a hardware macro for which no driver is provided. Moreover, specific code (for example, shaded portions of the application 120) is inserted into a location where processing to invoke a hardware macro is described in the application 120 simulated by the information processing apparatus 100.

When the application 120 to be verified is read, the virtual machine 110 successively performs a simulation and performs a simulation for a location where specific code is inserted by using information of the simulation model 130. Since the virtual machine 110 normally has no driver prepared for a corresponding hardware macro, it is impossible to execute the application 120 including processing to invoke the hardware macro.

In the information processing apparatus 100, however, the application can seamlessly be performed by switching a simulation by the virtual machine 110 to that using information of the simulation model 130 based on the specific code inserted into the application 120. Thus, in the verification support processing according to the present embodiment, predicted values of performance/power of the application can be obtained by referencing simulation results of the application 120 executed by the virtual machine 110.

A concrete configuration to implement verification support processing according to the present embodiment and operations thereof will successively be described below.

### (Configuration of the Virtual Machine)

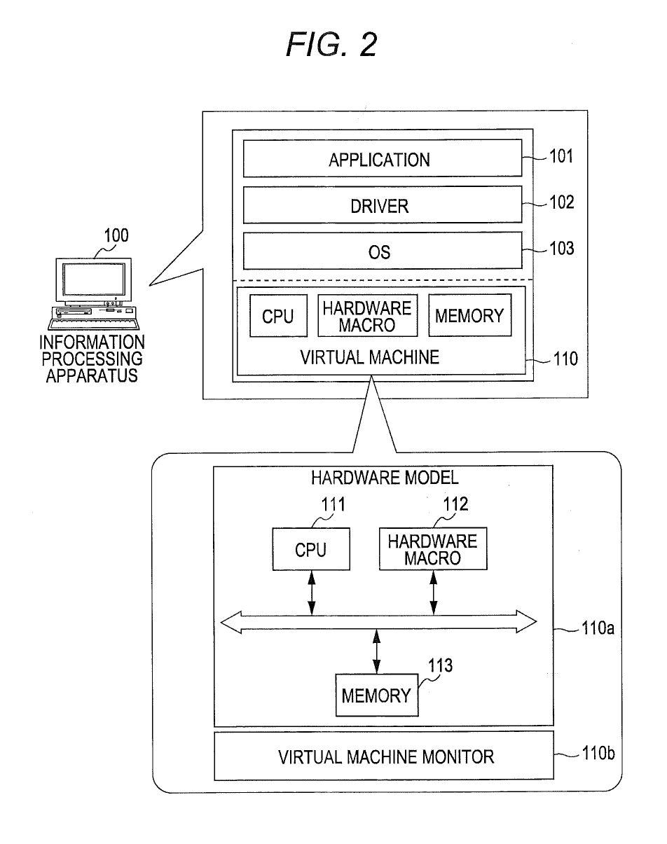

First, the configuration of the virtual machine 110 will be described. FIG. 2 is an explanatory view illustrating the configuration of a virtual machine according to the present embodiment. As illustrated in FIG. 2, the virtual machine 110 is configured by software in the information processing apparatus 100 according to the present embodiment. In the virtual machine 110, the hardware configuration of a target system caused to execute an application 101 is implemented by software as a hardware model 110a. The hardware model 110a implemented by the virtual machine 110 illustrated in FIG. 2 includes a CPU (model) 111, a hardware macro (model) 112, and a memory (model) 113. Further, the virtual machine 110 is provided with a virtual machine monitor 110b to control an operation of each piece of hardware (the CPU 111 to the memory 113) implemented by the hardware model 110a.

Then, the information processing apparatus 100 is provided with an OS 103 to cause the above virtual machine 110 to operate, a driver 102 corresponding to the hardware environment of the hardware model 110a, and the application 101 executed on the OS 103. While the driver 102 provided here is software to invoke the hardware macro 112 constituting the hardware model 110a, there is no need, as described above, to provide a portion of the hardware macro 112 the corresponding driver 102 of which is not developed.

### (Procedure for Basic Operations in the Virtual Machine)

Next, the procedure for basic operations of the virtual machine 110 will be described. When the application 101 is read, the virtual machine 110 in the above configuration carries out a predetermined operation. A result of this execution is output as a simulation result of operation.

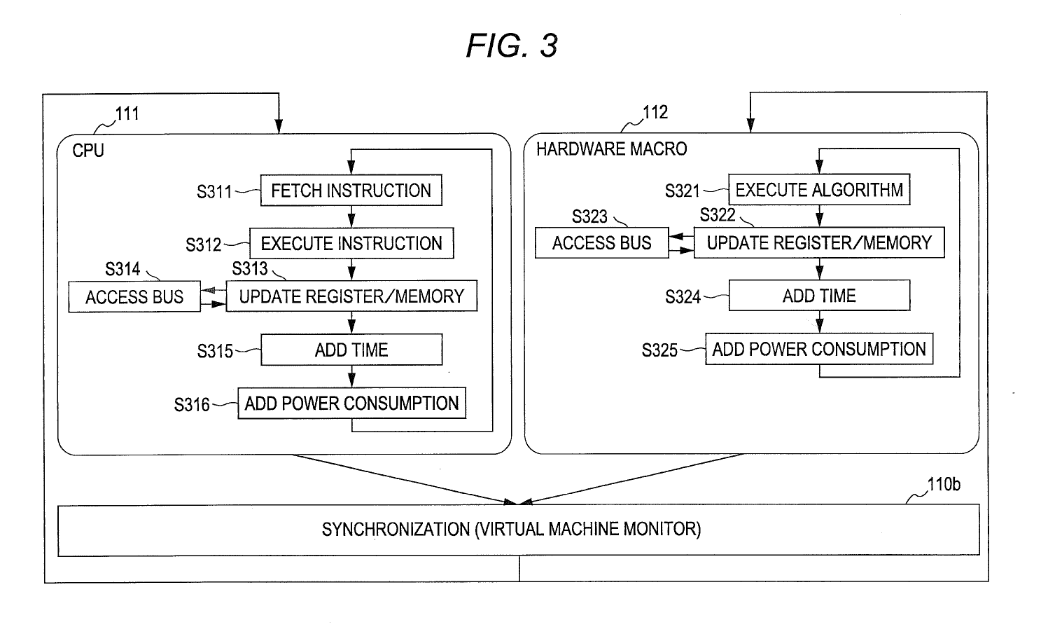

FIG. 3 is an explanatory view illustrating the procedure for basic operations in the virtual machine. In FIG. 3, the procedure for basic operations carried out by the virtual machine 110 is illustrated. When the application 101 is read, a predetermined operation is carried out by each of the CPU 111 and the hardware macro 112 in the virtual machine 110 in accordance with a description of the application 101. The memory 113 is also accessed by the CPU 111 and the hardware macro 112 when appropriate.

More specifically, the CPU 111 fetches an instruction from the application 101 (operation S311) and executes the fetched instruction (operation S312). Then, the CPU 111 updates a register/memory in accordance with the execution of the instruction (operation S313) and a bus is accessed in accordance with the update processing (operation S314). When the update is complete, the time and power consumption necessary when the same instruction is executed by a real machine are added (operations S315 and S316) before returning to operation S311 to fetch the next instruction. When the time and power consumption are added in operations S315 and S316, predicted values or measured values prepared in advance in accordance with performance of the real machine are added.

Similarly, the hardware macro 112 executes an algorithm in accordance with the description of the application 101 (operation S321) and updates a register/memory in accordance with the executed algorithm (operation S322) before the bus is accessed in accordance with the update processing (operation S323). When the update is complete, here also, the time and power consumption necessary when the same algorithm is executed by the real machine are added (operations S324 and S325) before returning to operation S321 to execute the next algorithm. When the time and power consumption are added in operations S324 and S325, here also, predicted values or measured values prepared in advance in accordance with performance of the real machine are added.

Synchronization control of operations by each of the CPU 111 and the hardware macro 112 described above is exercised by the virtual machine monitor 110b. Therefore, a simulation result through collaboration between the CPU 111 and the hardware macro 112 similar to the real machine can be obtained by acquiring an operation execution result by the virtual machine 110.

### (Hardware Configuration of the Information Processing Apparatus)

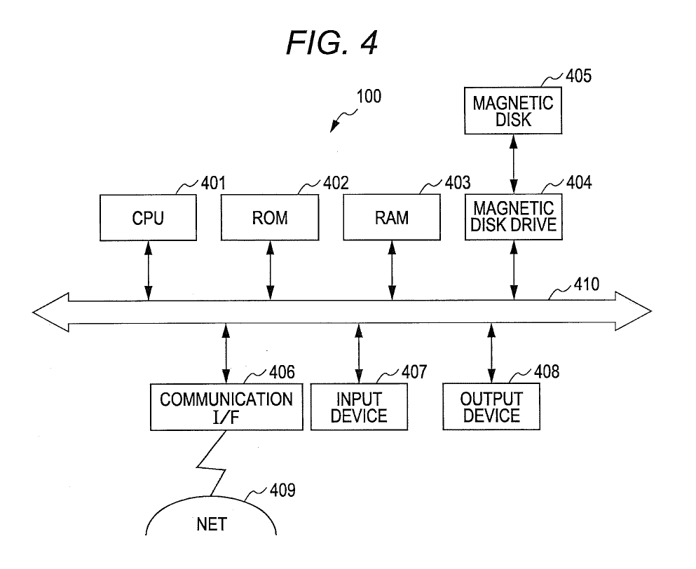

Next, the hardware configuration of the information processing apparatus 100 will be described concretely. FIG. 4 is a block diagram illustrating the hardware configuration of the information processing apparatus. In FIG. 4, the information processing apparatus 100 includes a CPU (Central Processing Unit) 401, a ROM (Read-Only Memory) 402, a RAM (Random Access Memory) 403, a magnetic disk drive 404, a magnetic disk 405, a communication I/F (interface) 406, an input device 407, and an output device 408. Moreover, each component is connected by a bus 410.

Here, the CPU 401 manages overall control of the information processing apparatus 100. The ROM 402 has various programs stored therein, such as a boot program and a verification support program, for implementing the verification support processing according to the present embodiment. The RAM 403 is used as a work area of the CPU 401. The magnetic disk drive 404 controls the update/reference of data on the magnetic disk 405 according to the control of the CPU 401. The magnetic disk 405 stores data written under control of the magnetic disk drive 404. While the magnetic disk 405 is used as a recording medium in the hardware configuration in FIG. 4, another recording medium such as an optical disk or flash memory may also be used.

The communication I/F 406 is connected to a network (NET) 409 such as a LAN (Local Area Network), a WAN (Wide Area Network), and the Internet via a communication line and connected to other information processing apparatuses 100 and other external apparatuses via the network 409. The communication I/F 406 manages the network 409 and the interface inside and controls input/output of data from external apparatuses. For example, a modem or LAN adapter can be adopted as a configuration example of the communication I/F 406.

The input device 407 accepts input to the information processing apparatus 100 from outside. A keyboard and a mouse can be cited as a concrete example of the input device 407. The application 101 that performs a simulation using the information processing apparatus 100 as illustrated in FIG. 2 may be stored in a storage area such as the ROM 402, the RAM 403 and the magnetic disk 405 in advance, but may also be stored in the storage area by being input through the input device 407.

A keyboard, which is provided with keys for inputting characters, numbers, and various instructions, is used to input data. The keyboard may be a touch-panel input pad or ten keys. A mouse is used, for example, to move the cursor, to select the range thereof, to move a window, or to change the size thereof. The mouse may be a trackball or joystick if equipped with a similar function as a pointing device.

The output device 408 outputs data distributed in the information processing apparatus 100 or simulation execution results. A display and a printer can be cited as a concrete example of the output device 408.

A display displays data such as documents, images, and functional information including, for example, the cursor, icons, and the toolbox. Further, a CRT, TFT liquid crystal display, or plasma display can be adopted as the display. A printer prints, for example, image data and document data. Further, a laser printer or ink jet printer can be adopted as the printer.

The information processing apparatus 100 according to the present embodiment can perform a simulation of the application 101, as described above, by using the virtual machine 110 (see FIG. 3), but cannot invoke processing correctly from the application 101 for the hardware macro 112 for which the driver 102 is not prepared. Therefore, a configuration to cause the above virtual machine 110 to execute the application 101 containing the hardware macro 112 for which the driver 102 is not prepared will be described.

### (Procedure for Performing a Simulation in the Information Processing Apparatus)

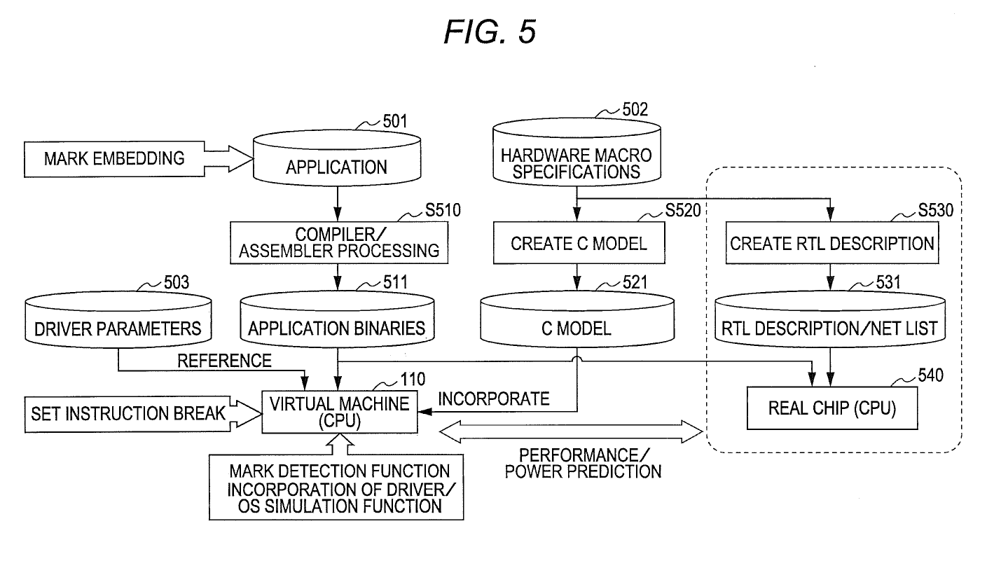

First, the procedure for performing a simulation of the application 101 containing the hardware macro 112 for which the driver 102 is not prepared by the information processing apparatus 100 will be described. FIG. 5 is an explanatory view illustrating the procedure for performing a simulation in the information processing apparatus.

As illustrated in FIG. 5, the information processing apparatus 100 is provided with an application 501, hardware macro specifications 502, and driver parameters 503 to prepare input information into the virtual machine 110. Of the above information, information excluding the driver parameters 503 is processed to create input information into the virtual machine 110.

First, the application 501 to be verified has specific code inserted into a readout location of the hardware macro 112 for which the driver 102 is not prepared. Here, a mark using an undefined instruction or an interrupt instruction is embedded as an insertion example of the specific code. The application 501 is a group of code described in a specific programming language and therefore, processing to convert the application 501 into application binaries 511 by a compiler or assembler (operation S510) is necessary to perform a simulation by the virtual machine 110.

The hardware macro specifications 502 set operation specifications of the hardware macro 112 for which the driver 102 is not prepared. Therefore, a C model 521, which is a simulation model of the hardware macro 112, is created by using the hardware macro specifications 502 (operation S520). The created C model 521 is incorporated into the virtual machine 110.

Instructions executed when the application 501 invokes the hardware macro 112 and processing is transferred from the hardware macro 112 to other hardware, and also predicted values of the execution time and power consumption are prepared as the driver parameters 503. These driver parameters 503 are referenced as setting values when the hardware macro 112 is invoked (details will be described later).

In addition to basic operations described with reference to FIG. 3, the virtual machine 110 includes a function to detect a mark inserted into the input application binaries 511 and a function to perform a simulation of the driver 102 and the OS 103 based on the detected mark. The virtual machine 110 can also be set so as to perform an instruction break in accordance with detection of a mark. The verifier can appropriately set in accordance with a verification purpose of the application 501 in the detection of which mark to perform an instruction break and further, into which portion of processing to invoke the hardware macro 112 contained in the application 501 to insert a mark.

The hardware macro specifications 502 used to create the C model 521 are also used to produce a real chip 540. In such a case, an RTL (Register Transfer Level) description is first created from the hardware macro specifications 502 (operation S530). Then, the real chip 540 is produced by using a created RTL description/net list (created from the RTL description) 531. Also, precision of a simulation can be checked by comparing performance/power when the produced real chip 540 is caused to execute the application 501 with performance/power predictions obtained from simulation results by the virtual machine 110.

### (Functional Configuration of the Virtual Machine)

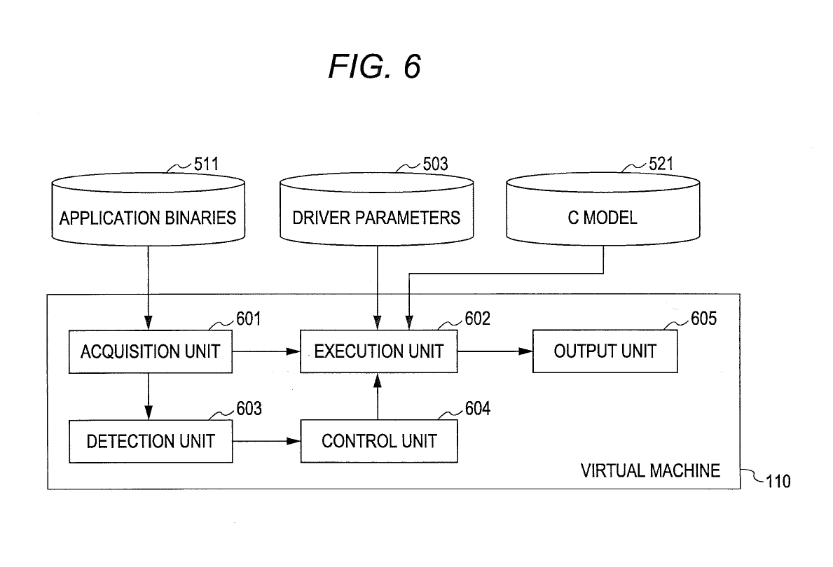

Next, the functional configuration of the virtual machine 110 implemented by the information processing apparatus 100 will be described. FIG. 6 is a block diagram illustrating the functional configuration of the virtual machine in the information processing apparatus. The virtual machine 110 implemented by the information processing apparatus 100 includes an acquisition unit 601, an execution unit 602, a detection unit 603, a control unit 604, and an output unit 605. Functions to be the control unit (the acquisition unit 601 to the output unit 605) are concretely implemented, for example, by causing the CPU 401 to execute programs stored in the storage area such as the ROM 402, the RAM 403, or the magnetic disk 405 illustrated in FIG. 4 or by the communication I/F 406.

The acquisition unit 601 has a function to acquire a simulation model of hardware to be added to an existing hardware environment and the application binaries 511 to make the application 501 to be verified execute. A simulation model of hardware to be added to the hardware environment acquired by the acquisition unit 601 is, for example, the C model 521 of the added hardware macro 112. The application binaries 511 are generated, as described above, by converting the application 501 and thus, has a mark inserted into a location in which invocation processing of the hardware macro 112 is performed. The acquired application binaries 511 are temporarily stored in a storage area such as the RAM 403 or the magnetic disk 405.

The execution unit 602 has a function to perform a simulation of the application 501 to be verified by executing the application binaries 511 using the virtual machine 110. A simulation normally means performing an operation of the CPU 111 or the hardware macro 112, as described with reference to FIG. 3.

The detection unit 603 has a function to detect a location into which specific code (for example, a mark as described above) is inserted from among the application binaries 511 being executed after execution of the application binaries 511 is started by the execution unit 602.

The control unit 604 controls execution of the application binaries 511 by the execution unit 602 in accordance with detection of a mark by the detection unit 603. More specifically, the application binaries 511 are executed using information of the C model 521 acquired by the acquisition unit 601 in a location detected as having a mark inserted thereinto. That is, the control unit 604 controls the execution unit 602 so that simulation information provided as the C model 521 is used during execution of an operation of the CPU 111 or the hardware macro 112 described with reference to FIG. 3.

The control unit 604 can also control whether or not to use information of the C model 521 during execution of a simulation of the application 501 by the execution unit 602 or presence/absence of the start and end of execution of a simulation using information of the C model 521 in accordance with the command set in a mark detected by the detection unit 603.

The output unit 605 outputs a simulation result of the application 501 by the execution unit 602, that is, an execution result of the application binaries 511. The form of output of such a result includes, for example, the display in a display provided as the output device 408, print output to a printer, and transmission to an external apparatus by the communication I/F 406. Such a result may also be stored in a storage area, such as the RAM 403 and the magnetic disk 405.

When a simulation using information of the C model 521 is performed by the virtual machine 110, as described with reference to FIG. 5, the driver parameters 503 can be referenced. Therefore, the control unit 604 can make a simulation using information of the C model 521 use parameters set in the driver parameters 503 as predicted values.

### (Procedure for Performing a Simulation in the Virtual Machine)

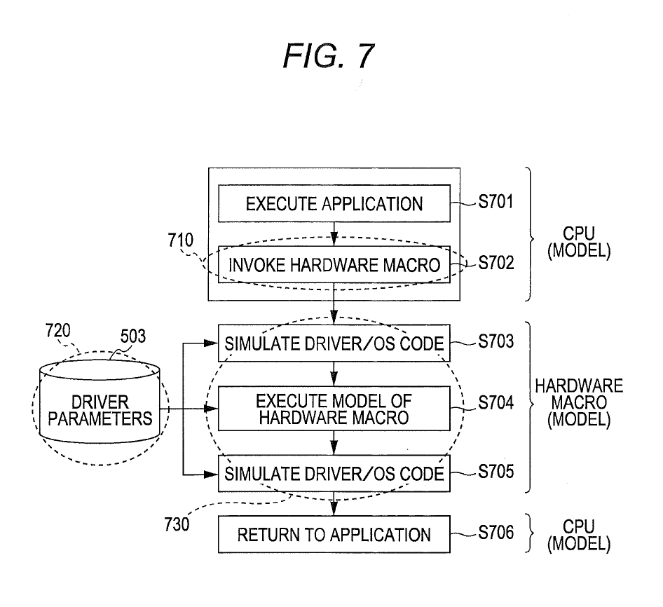

Next, the procedure for performing a simulation in the virtual machine 110 having the above configuration will be described. FIG. 7 is an explanatory view illustrating the procedure for performing a simulation using the virtual machine. FIG. 7 illustrates a process procedure for a simulation of the application 501 in which a process to invoke the hardware macro 112 arises while a normal simulation is being performed and then a simulation corresponding to the hardware macro 112 is performed before returning to execution of the normal simulation again.

Therefore, in the virtual machine 110, the target whose processing is controlled is switched between the CPU (model) 111 and the hardware macro (model) 112 in accordance with a description of the application being executed. At operations S701 and S702, a normal simulation is performed and thus, processing is performed by the CPU 111. Then, processing at operations S703 to S705 after the hardware macro 112 being invoked is performed by the hardware macro 112. Operation S706 at which the normal simulation returns after the simulation by the hardware macro 112 is completed is processed by the CPU 111 again.

A sequence of processes illustrated in FIG. 7 is characterized by processes 710 and 730 and a configuration 720 enclosed by a broken line circle. In the process 710, processing to switch the control target of the virtual machine 110 is performed by recognizing a mark inserted into a location where the hardware macro 112 is invoked by the application 501 (actually, the application binaries 511). At this point, a location into which a mark is inserted includes, for example, a portion of description such as an undefined instruction/unused interrupt/break.

The configuration 720 illustrates a configuration in which when the driver 102 or the OS 103 whose execution is assumed in the virtual machine 110 actually invokes the hardware macro 112 in the application 501, a sequence of execution instructions whose execution is assumed before or after invocation processing, the execution time/power consumption values and the like are stored as the driver parameters 503.

In the process 730, processing to perform a simulation based on code of the driver 102 and the OS 103 by referencing the driver parameters 503 provided as the configuration 720 after the control target of the virtual machine 110 being switched to the hardware macro 112 by the process 710 (operation S703), to invoke the C model 521 by the hardware macro 112 (operation S704), and to return the control target of the simulation to the CPU 111 by performing a simulation based on the code of the driver 102 and the OS 103 after the invocation of the C model 521 being completed (operation S705) are performed. The virtual machine 110 can restore the normal simulation by switching the control target of the simulation back to the CPU 111 (operation S706).

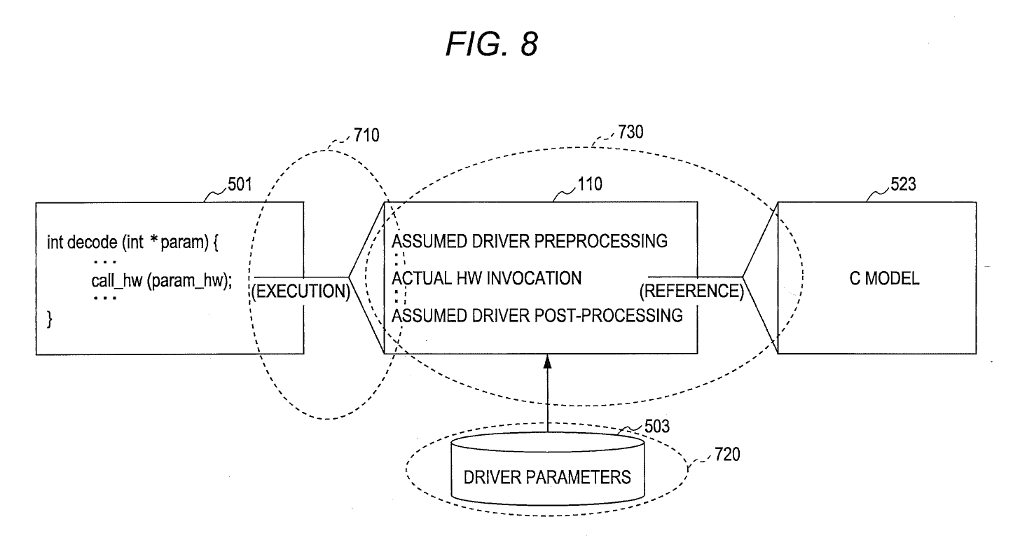

Here, FIG. 8 is a model diagram illustrating an example of hardware macro invocation by the virtual machine. As illustrated in FIG. 8, when the application 501 into which a mark is inserted is executed, the virtual machine 110 references the C model 521 of the hardware macro 112 to implement processing to invoke the hardware macro 112. In the model diagram illustrated in FIG. 8, broken line circles with the same reference numerals as that in FIG. 7 are illustrated in locations corresponding to the processes 710 and 730 and the configuration 720 described above.

Process 710 (Mark Insertion into the Application)

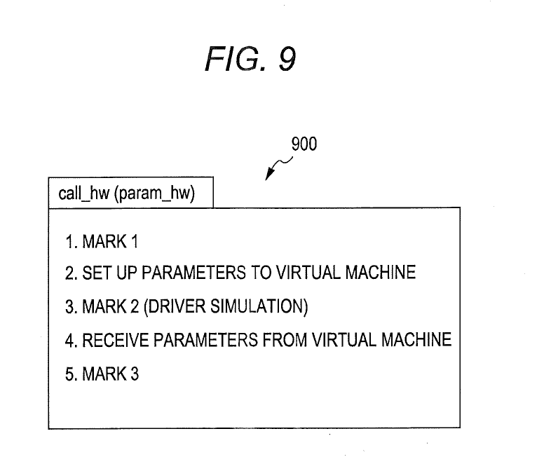

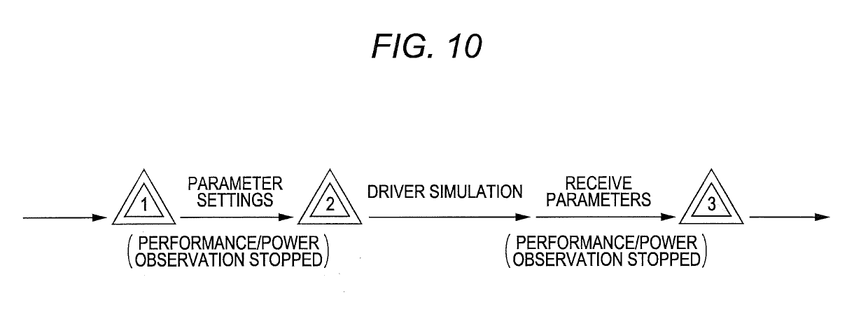

Next, the process 710 will be described in detail. In the application 501 illustrated in FIG. 8, a mark is inserted into a location where “call_hw” is described. FIG. 9 is an explanatory view illustrating a description example of an application including a hardware macro invocation. In the location of the application 501 where “call_hw” is described, a mark such as a description example 900 and a corresponding instruction are described as a set. FIG. 10 is an explanatory view illustrating simulation control of the virtual machine in accordance with mark detection.

Processing content of the description example 900 in FIG. 9 will be described using FIG. 10. First, with embedding of a mark 1, performance/power observations being performed by the virtual machine 110 is stopped. When performance/power observations being performed by the CPU 111 of the virtual machine 110 is stopped using the mark 1 as a trigger, parameters to the virtual machine 110 are then set. For parameters set here, the driver parameters 503 are referenced.

After parameters are set, the control target of the virtual machine 110 is switched using a mark 2 as a trigger and then, a driver simulation by the hardware macro 112 is performed. After the driver simulation by the virtual machine 110 is completed, original parameters switched by using the mark 1 as a trigger are received and reset to the virtual machine 110. Then, performance/power observations that were performed by the CPU 111 of the virtual machine 110 are restarted by using a mark 3 as a trigger. Both the CPU 111 and the hardware macro 112 of the virtual machine 110 stop performance/power observations when parameters are set between the mark 1 and the mark 2 and when parameters are received between the end of driver simulation and the mark 3.

Insertion of each mark can be implemented by techniques described below. For #pragma inside call_hw, for example, the CPU 111 of the virtual machine 110 embeds code to be an undefined instruction and a simulation result concerning an undefined exception accompanying execution thereof can be captured by the virtual machine 110. Or, an unused software interrupt (SWI) may be embedded in call_hw so that a simulation result of an interrupt accompanying execution thereof can be captured by the virtual machine 110. Further, an instruction break held by the CPU 111 of the virtual machine 110 may be set in a specific location of call_hw so that a simulation result using the instruction break as a trigger can be captured by the virtual machine 110.

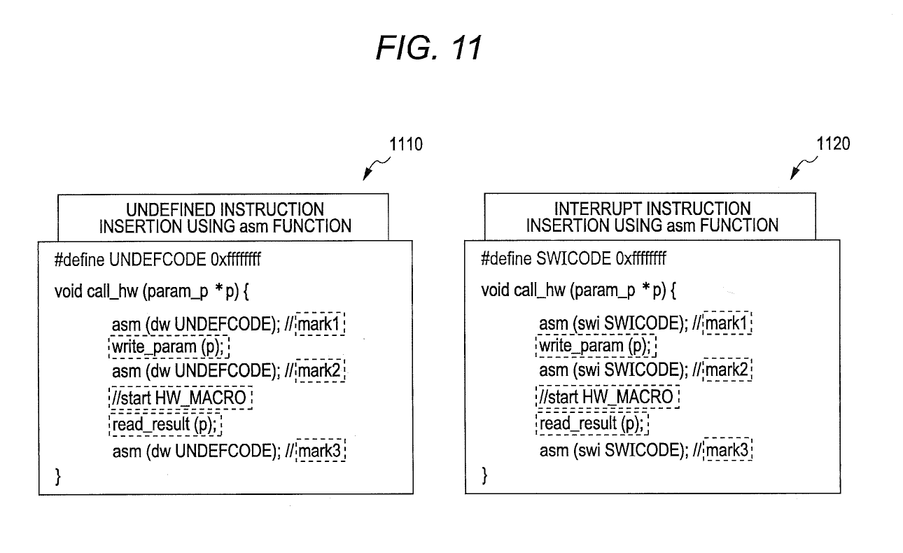

FIG. 11 is an explanatory view illustrating mark insertion examples of the application. In a description example 1110, undefined instructions using an asm function are inserted by using marks (the mark 1 to the mark 3). In a description example 1120, interrupt instructions using the asm function are inserted by using marks (the mark 1 to the mark 3). In addition, instruction break functions held by a debugger or the like can be inserted by using marks (the mark 1 to the mark 3).

### Configuration 720 (Storage of Parameters in Driver Parameters)

Next, the configuration 720 will be described in detail. The configuration 720 is a configuration of the driver parameters 503 and each parameter value stored in the driver parameters 503 is obtained by techniques described below. First, parameters related to execution time/power information are obtained by causing the virtual machine 110 to perform a driver similar to the driver 102 corresponding to the hardware macro 112 to use execution time/power information during execution. Instead of using a similar driver, parameters concerning execution time/power information may manually be stored based on experience of the verifier. Parameters to be set when a simulation of the hardware macro 112 is performed are stored by separately acquiring them from information of the C model 521.

In addition, the execution time and power information value assumed based on preprocessing/post-processing during execution of a simulation of the hardware macro 112 by adjusting to processing content of the assumed or targeted driver 102 may be generated and stored as parameters.

### Process 730 (Simulation by the Virtual Machine 110)

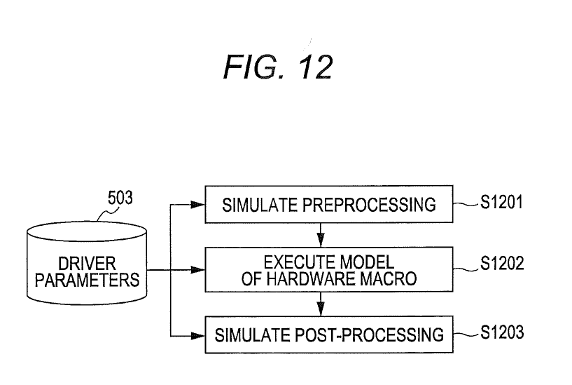

Lastly, the process 730 will be described in detail. In the process 730, a simulation by the virtual machine 110 is performed. Here, FIG. 12 is an explanatory view illustrating the simulation procedure of the virtual machine including the hardware macro. As illustrated in FIG. 12, the virtual machine 110 first performs a simulation of a preprocessing unit (operation S1201). In the processing at operation S1201, the execution time of the simulation and power consumption value of the preprocessing unit are adjusted (added) based on performance/power information of the preprocessing unit stored in the driver parameters 503.

When the processing at operation S1201 is completed, the C model 521 of the hardware macro 112 is subsequently invoked and performed (operation S1202). When the processing at operation S1202 is completed, the virtual machine 110 performs a simulation of a post-processing unit (operation S1203). In the processing at operation S1203, the execution time of the simulation and power consumption value of the post-processing unit are adjusted (added) based on performance/power information of the post-processing unit stored in the driver parameters 503.

In this manner, the virtual machine 110 can perform a simulation using the C model 521 in correct processing locations by extracting marks. Further, correct simulation results can be obtained by referencing parameter values stored in the driver parameters 503.

(Development Operations when Verification Support Processing According to the Present Embodiment is Applied)

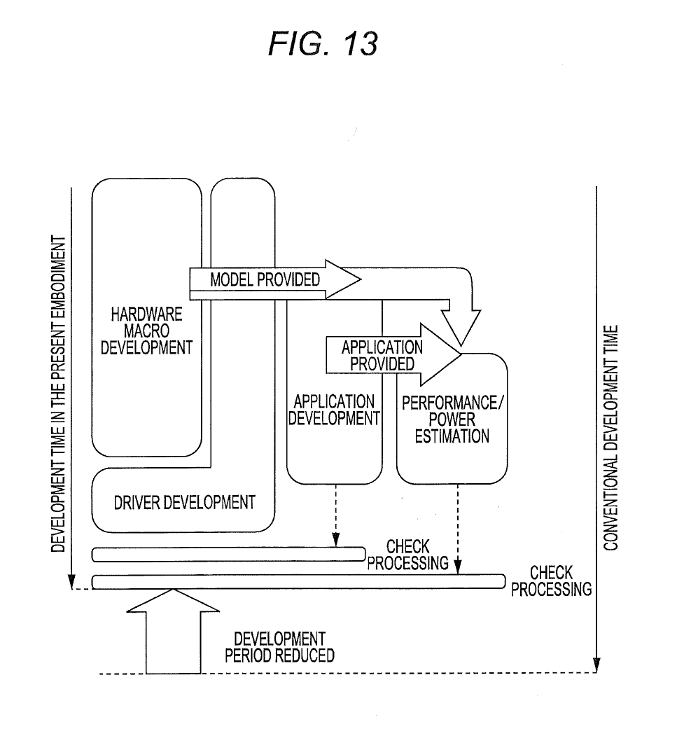

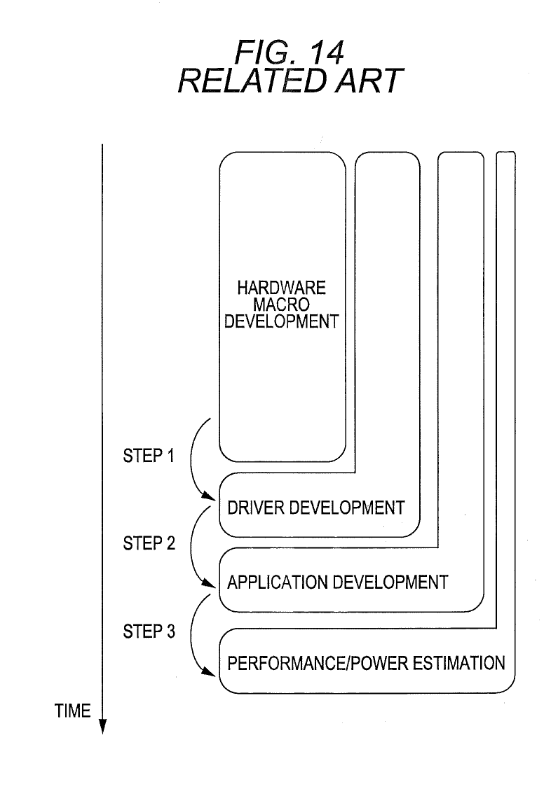

Here, FIG. 13 is an explanatory view illustrating application development operations when the present embodiment is applied. As illustrated in FIG. 13, if the information processing apparatus 100 according to the present embodiment is used, development of an application can be started in an earlier stage without waiting for, like conventional development operations (see FIG. 14), development of a hardware macro and a driver. More specifically, as illustrated in FIG. 13, development of an application can immediately be started even when development of a hardware macro is started if a C model for the hardware macro is prepared.

Moreover, an application can be verified simultaneously with development of a hardware macro and a driver corresponding to the hardware macro. Therefore, feedback of verification results can be given to development of a hardware macro and a driver. Simulation results of an application can also be obtained in an earlier stage of a hardware macro development process or driver development process and therefore, feedback of performance evaluation can be given to hardware.

According to the present embodiment, as described above, the virtual machine 110 switches to execution content of any one of a normal simulation and a simulation using the C model 521 in accordance with a mark detected from the application 501. By performing a simulation using the C model 521 in this manner, invocation processing of the hardware macro 112 that can originally be performed only via the driver 102 can be made to perform as if the hardware macro 112 were invoked via the driver 102.

Thus, in the present embodiment, an application can be made to operate with a hardware macro included by using the virtual machine 110 even in an early stage of development operations in which a driver has not yet been developed. Therefore, performance/power can be measured/predicted at a system level of application without waiting for the development of a hardware macro so that a high-precision verification environment can be provided.

Verification support processing according to the present embodiment is not limited to implementation as the above information processing apparatus 100 and is applicable to, for example, hardware for specific applications or low-power tools that estimate performance/power of a multi-core system.

The verification support method described in the present embodiment can be implemented by executing a program prepared in advance on a computer such as a personal computer or workstation. The program is recorded in a computer readable recording medium such as a hard disk, flexible disk, CD-ROM, MO, and DVD and executed by being read by the computer from the recording medium. The program may also be a medium that can be delivered via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer-readable recording medium storing a verification support program that causes a computer to execute:
executing a simulation of an application executed by a system using a virtual machine implementing a hardware environment of the system by software;
acquiring a simulation model of hardware to be added to the hardware environment and inserting specific code into the application in a location where the hardware to be added is invoked;
detecting the location into which the specific code is inserted from the application being executed when the application acquired by the acquiring procedure is executed by the executing procedure;
perform-controlling the simulation of the application by using information of the simulation model acquired by the acquiring procedure in the location where insertion of the specific code is detected by the detecting procedure by controlling the executing procedure; and
outputting a simulation result of the application by the executing procedure.

2. The computer-readable recording medium according to claim 1,
wherein the perform-controlling procedure controls a simulation of the application using the virtual machine and an execution start and end of the simulation of the application using information of the simulation model in accordance with a command set in the specific code detected by the detecting procedure.

3. The computer-readable recording medium according to claim 1,
wherein the acquiring procedure further acquires predicted values of parameters when the application invokes the hardware to be added, and
wherein the perform-controlling procedure sets the predicted values as parameters and then causes the executing procedure to perform a simulation of the application using the simulation model acquired by the acquiring procedure in the location where insertion of the specific code is detected by the detecting procedure.

4. The computer-readable recording medium according to claim 2,
wherein the acquiring procedure further acquires predicted values of parameters when the application invokes the hardware to be added, and
wherein the perform-controlling procedure sets the predicted values as parameters and then causes the executing procedure to perform a simulation of the application using the simulation model acquired by the acquiring procedure in the location where insertion of the specific code is detected by the detecting procedure.

5. The computer-readable recording medium according to claim 1,
wherein the perform-controlling procedure sets parameters set when the simulation is terminated to a simulation of the application using the virtual machine to cause the executing procedure to perform the simulation, if a simulation of the application using the simulation model is terminated.

6. The computer-readable recording medium according to claim 2,
wherein the perform-controlling procedure sets parameters set when the simulation is terminated to a simulation of the application using the virtual machine to cause the executing procedure to perform the simulation, if a simulation of the application using the simulation model is terminated.

7. The computer-readable recording medium according to claim 3,
wherein the perform-controlling procedure sets parameters set when the simulation is terminated to a simulation of the application using the virtual machine to cause the executing procedure to perform the simulation, if a simulation of the application using the simulation model is terminated.

8. The computer-readable recording medium according to claim 4,
wherein the perform-controlling procedure sets parameters set when the simulation is terminated to a simulation of the application using the virtual machine to cause the executing procedure to perform the simulation, if a simulation of the application using the simulation model is terminated.

9. The computer-readable recording medium according to claim 1,
wherein the acquiring procedure acquires an application in which specific code is inserted into a location of an undefined instruction concerning the hardware to be added.

10. The computer-readable recording medium according to claim 2,
wherein the acquiring procedure acquires an application in which specific code is inserted into a location of an undefined instruction concerning the hardware to be added.

11. The computer-readable recording medium according to claim 3,
wherein the acquiring procedure acquires an application in which specific code is inserted into a location of an undefined instruction concerning the hardware to be added.

12. The computer-readable recording medium according to claim 4,
wherein the acquiring procedure acquires an application in which specific code is inserted into a location of an undefined instruction concerning the hardware to be added.

13. The computer-readable recording medium according to claim 1,
wherein the acquiring procedure acquires an application in which specific code is inserted into a location of an unused interrupt concerning the hardware to be added.

14. The computer-readable recording medium according to claim 2,
wherein the acquiring procedure acquires an application in which specific code is inserted into a location of an unused interrupt concerning the hardware to be added.

15. The computer-readable recording medium according to claim 3,
wherein the acquiring procedure acquires an application in which specific code is inserted into a location of an unused interrupt concerning the hardware to be added.

16. The computer-readable recording medium according to claim 1,
wherein the acquiring procedure acquires an application in which specific code is inserted into a break location concerning the hardware to be added.

17. The computer-readable recording medium according to claim 2,
wherein the acquiring procedure acquires an application in which specific code is inserted into a break location concerning the hardware to be added.

18. The computer-readable recording medium according to claim 3,
wherein the acquiring procedure acquires an application in which specific code is inserted into a break location concerning the hardware to be added.

19. An information processing apparatus having a verification support function, comprising:
an execution unit executing a simulation of an application executed by a system using a virtual machine implementing a hardware environment of the system by software;
an acquisition unit acquiring a simulation model of hardware to be added to the hardware environment, the application having specific code inserted into a location where the hardware to be added is invoked;
a detection unit detecting the location into which the specific code is inserted from the application being executed when the application acquired by the acquisition unit is executed by the execution unit;
a control unit performing the simulation of the application by using information of the simulation model acquired by the acquisition unit in the location where insertion of the specific code is detected by the detection unit by controlling the execution unit; and
an output unit outputting a simulation result of the application by the execution unit.

20. A verification support method that causes a computer to execute:
executing a simulation of an application executed by a system using a virtual machine implementing a hardware environment of the system by software;
acquiring a simulation model of hardware to be added to the hardware environment and inserting specific code into the application in a location where the hardware to be added is invoked;
detecting the location into which the specific code is inserted from the application being executed when the application acquired by the acquiring operation is executed by the executing operation;
switching to a simulation of the application using information of the simulation model acquired by the acquiring operation in the location where insertion of the specific code is detected by the detecting operation; and
outputting a simulation result of the application.
